(19) United States
(12) Patent Application Publication
(10) Pub. No.: US 2019/0266851 A1
(43) Pub. Date: Aug. 29, 2019

(54) GAME SYSTEM, MANAGEMENT APPARATUS, AND GAME APPARATUS

(71) Applicant: SEGA SAMMY CREATION INC., Yokohama-shi, Kanagawa (JP)

(72) Inventor: Daisuke Fujiki, Yokohama-shi (JP)

(21) Appl. No.: 16/342,303

(22) PCT Filed: Oct. 21, 2016
(86) PCT No.: PCT/JP2016/081334

§ 371 Date: Apr. 16, 2019

(51) Int. Cl. G07F 17/32

(52) U.S. Cl. CPC G07F 17/3293; G07F 17/3225; G07F 17/3211

(57) ABSTRACT

A game system comprises a management apparatus comprising: a storage unit which stores a dividend amount associated with each rank of cards constituting a hand of a four of a kind in poker; an adding unit which distributes and adds at least a part of an amount having been bet at each of the game apparatuses to each dividend amount stored in the storage unit; a changing unit which transmits an instruction to pay a dividend amount associated with a rank of cards constituting the hand, to the game apparatus at which the hand has been formed, and changes the dividend amount that is associated with the rank of cards constituting the hand and is transmitted from the game apparatus, to an initial amount; and a transmitting unit which transmits data of the added or changed dividend amount to each of the plurality of game apparatuses.

### CROSS-REFERENCE TO RELATED APPLICATIONS

This application is the U.S. national phase of the International Patent Application No. PCT/JP2016/081334 filed Oct. 21, 2016, the entire content of which is incorporated herein by reference.

### TECHNICAL FIELD

The present disclosure relates to a game system, a management apparatus, and a game apparatus.

### BACKGROUND

Japanese Patent Publication JP 2008-154715 A discloses a technique related to a poker game machine. In the poker game machine according to Japanese Patent Publication JP 2008-154715 A, when a combination of cards dealt last is a specific combination (for example, a flush of hearts or diamonds), a winning percentage of a player is increased in a next game, and prior to the next game, a special game for determining game conditions is performed.

### SUMMARY

Hands in the game of poker include a four of a kind (4 of a kind). A four of a kind is a hand formed when there are four cards of a same rank. A four of a kind is a hand of which a dividend is relatively large and is a hand that is relatively easy to form or a hand which a player is relatively easily motivated to form. Generally, cards used in a poker game include 13 ranks such as A (ace), 2, 3, 4, 5, 6, 7, 8, 9, 10, J (jack), Q (queen), and K (king). Therefore, for example, a four of a kind of “3” may be formed in some cases while a four of a kind of “K” may be formed in other cases. However, a dividend amount in accordance with a rank of the cards constituting a four of a kind is uniformly determined. Therefore, since a user never develops an interest in a rank of the cards constituting a four of a kind and an expected value does not change depending on the rank to form a four of a kind, games tend to become monotonous.

In consideration thereof, an object of the disclosure is to provide a game system, a management apparatus, and a game apparatus which diversify options when a user selects a card by varying dividends of a four of a kind.

A game system according to one embodiment comprises a management apparatus which manages a plurality of game apparatuses, the management apparatus comprising: a storage unit which stores a dividend amount associated with each rank of cards constituting a hand of a four of a kind in poker; an adding unit which distributes and adds at least a part of an amount having been bet at each of the game apparatuses to each dividend amount stored in the storage unit; a changing unit which, when the hand of a four of a kind is formed at any of the game apparatuses, transmits an instruction to pay a dividend amount associated with a rank of cards constituting the hand, to the game apparatus at which the hand has been formed, and changes the dividend amount that is associated with the rank of cards constituting the hand and is transmitted from the game apparatus, to an initial amount; and a transmitting unit which transmits data of the added or changed dividend amount to each of the plurality of game apparatuses.

A control method according to an embodiment is a control method of a management apparatus which manages a plurality of game apparatuses, the control method comprising the steps of: distributing and adding at least a part of an amount having been bet at each of the game apparatuses to each dividend amount stored in a storage unit which stores a dividend amount associated with each rank of cards constituting a hand of a four of a kind in poker; when the hand of a four of a kind is formed at any of the game apparatuses, transmitting an instruction to pay a dividend amount associated with a rank of cards constituting the hand, to the game apparatus at which the hand has been formed, and changing the dividend amount that is associated with the rank of cards constituting the hand and is transmitted from the game apparatus, to an initial amount; and transmitting data of the added or changed dividend amount to each of the plurality of game apparatuses.

A control method according to an embodiment is a control method of a game apparatus which is managed by a management apparatus, the control method comprising the steps of: receiving, from the management apparatus, a dividend amount associated with each rank of cards constituting a hand of a four of a kind in poker; displaying the dividend amount on a display unit; when the hand of a four of a kind is formed, transmitting a rank of cards constituting the hand to the management apparatus, and paying a dividend amount associated with the rank of cards constituting the hand based on an instruction to pay the dividend amount transmitted from the management apparatus; and transmitting data of an amount having been bet to the management apparatus.

According to an embodiment, a game system, a management apparatus, and a game apparatus which diversify options when a user selects a card can be provided.

### BRIEF DESCRIPTION OF DRAWINGS

Various embodiments are illustrated in the drawings, in which:

FIG. 1 is a schematic configuration diagram of a game system according to an embodiment.

FIG. 2 is a system block diagram of a server computer.

FIG. 3 is an external view of a station apparatus.

FIG. 4 is a block diagram of a station apparatus.

FIG. 5 is a block diagram showing a functional configuration of a server computer and a station apparatus.

FIG. 6 is a diagram showing an example of a game screen of poker.

FIG. 7 is a diagram explaining a dividend amount.

FIG. 8 is a diagram showing an example of a screen when a hand is formed.

FIG. 9 is a flow chart showing an example of a control method of a station apparatus.

FIG. 10 is a flow chart showing an example of a control method of a server computer.

FIG. 11 is a flow chart showing an example of a control method of a server computer.

### DETAILED DESCRIPTION

An embodiment of the present disclosure will be described with reference to the accompanying drawings. It should be noted that, in the respective diagrams, elements with a same reference sign share a same or similar configuration.

### Card Game System

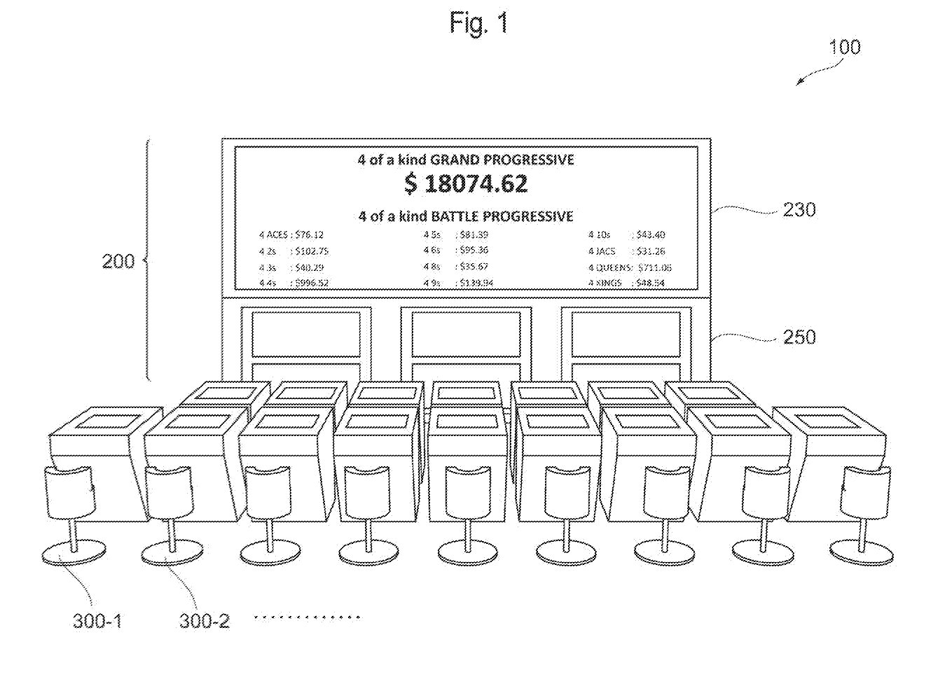

FIG. 1 is a schematic configuration diagram of a game system 100 according to the present embodiment. The game system 100 is provided with a master apparatus 200 and a plurality of station apparatuses 300-1, 300-2, . . . , 300-N. Hereinafter, when the plurality of station apparatuses 300-1, 300-2, . . . , 300-N need not be particularly distinguished from each other, the plurality of station apparatuses 300-1, 300-2, . . . , 300-N will be collectively referred to as the station apparatus 300. In the present embodiment, the master apparatus 200 will be used as an example of a management apparatus and the station apparatus 300 will be used as an example of a game apparatus.

The master apparatus 200 and the station apparatus 300 are respectively connected by a wired communication system, a wireless communication system, or the like via communication networks such as a LAN (Local Area Network) and a WAN (Wide Area Network). A user to participate in a game takes a seat at a vacant station apparatus 300. Subsequently, the user bets a desired amount of chips to start the game.

The master apparatus 200 manages a dividend amount of a card game (in the present embodiment, a poker game) which proceeds at each station apparatus 300. Each station apparatus 300 is an apparatus at which a poker game is played by each user.

A poker game is a game in which a dividend in accordance with an amount bet by each user (hereinafter, referred to as a “bet amount”) or the like is awarded when a combination identified by a suit (spades, clubs, hearts, or diamonds) and ranks of five cards dealt to the user matches a prescribed combination. A combination of dealt cards matching a prescribed combination is referred to as “a hand is formed”.

In the present embodiment, a plurality of hands obtained by subdividing the hand of a four of a kind are newly created. Specifically, hands corresponding to ranks of cards constituting a hand of a four of a kind (since there are 13 ranks from “A” to “K” of cards constituting a hand of a four of a kind, 13 hands) are newly created. These hands will be referred to as “four Xs” (4 Xs). The 13 ranks of cards from “A” to “K” are substituted into “X”. For example, the formation of a four of a kind of “2” will be referred to as “four 2s”. The formation of a four of a kind of “K” will be referred to as “four Ks”. The term “four Xs” is used when indicating matters common to the newly created 13 hands without distinguishing between the individual hands. Furthermore, in the present embodiment, a single incidental hand is newly created which is formed when a four of a kind is formed and when a card satisfying a specific condition but not constituting the hand is a specific card. The newly created hand will be referred to as a “four grand”. Dividend amounts are respectively set to the newly created “four Xs” and “four grand”. In other words, dividend amounts respectively associated with the newly created 14 hands (13 four Xs and 1 four grand) are set.

In the present embodiment, the dividend amounts associated with the newly created hands are not fixed amounts but are variable amounts. In the present embodiment, every time a user places a bet, an amount corresponding to a part of the bet amount (for example, an amount corresponding to 1 percent of the bet amount) is distributed to each newly created hand and added to a current dividend amount associated with each hand. An amount on which an amount corresponding to a part of a bet amount is accumulated in this manner will be referred to as a “progressive accumulated amount”. Each newly created hand is associated with a progressive accumulated amount. When a hand of a four of a kind is formed, the progressive accumulated amount associated with a rank (the “X” of four Xs) constituting the hand is to be paid as a dividend amount. A progressive accumulated amount is also a variable amount that is changed to an initial amount once a hand is formed. In other words, when any of the newly created hands is formed, the progressive accumulated amount associated with the formed hand is changed to an initial amount and accumulation starts once again from the initial amount.

The master apparatus 200 shown in FIG. 1 is provided with a server computer 250 which manages the respective progressive accumulated amounts, a main monitor 230, and the like. For example, as shown in FIG. 1, the main monitor 230 displays progressive accumulated amounts (dividend amounts) related to a poker game currently in progress. In the present specification, the term progressive accumulated amount and the term dividend amount are synonymously used.

The main monitor 230 of the master apparatus 200 shown in FIG. 1 displays texts reading “4 of a kind BATTLE PROGRESSIVE” (hereinafter, referred to as “battle progressive”) and “4 of a kind GRAND PROGRESSIVE” (hereinafter, referred to as “grand progressive”). A battle progressive is a progressive accumulated amount of a hand of a four Xs. In other words, a battle progressive is a progressive accumulated amount of each hand in accordance with a rank of cards constituting a hand of a four of a kind (in other words, one of 13 progressive accumulated amounts). A grand progressive is a progressive accumulated amount of a hand of a four grand. In other words, a grand progressive is a progressive accumulated amount of a hand which is formed when a four of a kind is formed and when a card satisfying a specific condition but not constituting the hand is a specific card. As described earlier, these progressive accumulated amounts are amounts to which amounts corresponding to a part of amounts bet by the respective users are being added in succession. Each of the displayed progressive accumulated amounts increases every time a game is played on each station apparatus 300.

As described above, in the present embodiment, new hands (four Xs) which are formed based on a rank of cards constituting a hand of a four of a kind and a hand (four grand) which is formed based on a card not constituting the hand of a four of a kind when specific conditions are satisfied in the event that a four of a kind is formed are newly created. In addition, a progressive accumulated amount is set to each newly created hand. As described earlier, when a hand is formed, a process (a first process) of changing a progressive accumulated amount associated with the hand to an initial amount is performed. In addition, in the present embodiment, a process (a second process) of varying a percentage when distributing an amount corresponding to a part of a bet amount to each hand is performed. When at least one of the processes of the first process and the second process is performed, the dividend amount associated with a newly created hand becomes a variable amount. Accordingly, the dividend to be paid when a hand of a four of a kind is formed becomes a variable money amount that dynamically changes instead of a fixed amount. In this manner, by varying dividends when a hand of a four of a kind is formed, options when a user selects a card can be diversified. In addition, executing both the first process and the second process widens disparities among the respective dividend amounts and increases a variation in the respective dividend amounts. Details will be provided later.

While a mode of displaying each progressive accumulated amount on the main monitor 230 has been described in the example shown in FIG. 1, what kind of information is to be displayed on the main monitor 230 in what mode can be appropriately configured and changed in accordance with how the master apparatus 200 or the like is designed.

### Master Apparatus

### Server Computer

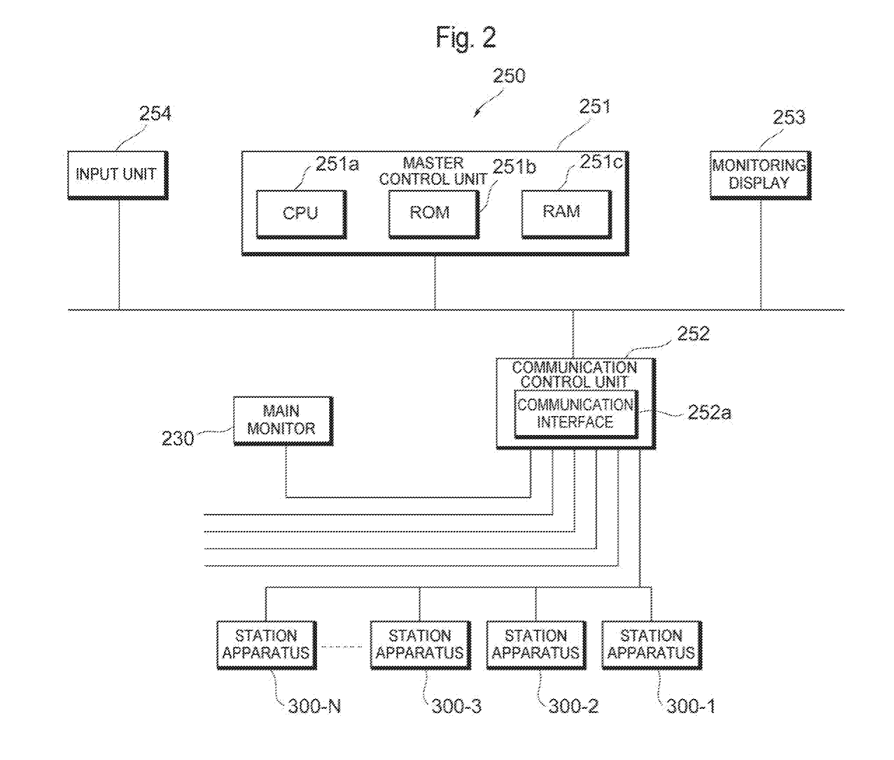

FIG. 2 is a system block diagram of the server computer 250 provided in the master apparatus 200. The server computer 250 is provided with a master control unit 251, a communication control unit 252, a monitoring display 253, and an input unit 254.

In addition to a menu screen and the like, the monitoring display 253 of the server computer 250 displays a maintenance screen for a person having a specific authority with respect to a card game (for example, an operator or the like of the card game; hereinafter, referred to as an “operator or the like” when appropriate) to perform maintenance work. By operating a keyboard, a mouse, and the like provided in the input unit 254, the operator or the like is able to perform various maintenance work comprising setting and adjusting display brightness and volume of the main monitor 230.

The master control unit 251 has a function of centrally controlling the master apparatus 200 and is provided with a CPU (Central Processing Unit) 251a, a ROM (Read Only Memory) 251b, a RAM (Random Access Memory) 251c, and the like. The CPU 251a is connected to a timer (not shown) and the like via a bus. The master control unit 251 transmits and receives data to and from each station apparatus 300 via a communication interface 252a.

Based on a signal supplied from each station apparatus 300 and data and programs stored in the ROM 251b and the RAM 251c, the CPU 251a performs various processes and transmits various instruction commands to each station apparatus 300 based on results of the processes.

The ROM 251b stores a program for realizing basic functions of the master apparatus 200, a program for initiatively controlling the respective station apparatuses 300, and the like. While a read-only ROM 251b is assumed in the present embodiment, a writeable EEPROM (Electrically Erasable Programmable Read-Only Memory) may be used in place of the ROM 251b. When using an EEPROM, the operator or the like can rewrite the various programs, data, and the like stored in the EEPROM at appropriate timings.

The RAM 251c stores each progressive accumulated amount updated based on at least a part of a bet amount transmitted from each station apparatus 300, various data transferred from the ROM 251b, results of processes executed by the CPU 251a, and the like. Each station apparatus 300 transmits data indicating a bet amount to the master apparatus 200. The master apparatus 200 updates each progressive accumulated amount stored in the RAM 251c based on the received data and transmits the updated data to each station apparatus 300. Accordingly, at each station apparatus 300, each progressive accumulated amount reflecting an amount having been bet at another station apparatus 300 is displayed.

In addition, when a hand of a four of a kind is formed at each station apparatus 300, information (a suit and a rank) of five cards is transmitted to the master apparatus 200. The master apparatus 200 having received the data specifies a rank constituting the hand of a four of a kind and transmits an instruction for payment of a dividend amount associated with the specified rank to the station apparatus 300 at which the hand has been formed. In addition, the master apparatus 200 changes the dividend amount (the progressive accumulated amount) associated with the rank constituting the hand of a four of a kind to an initial amount and transmits data of the changed dividend amount to each station apparatus 300. A common amount (in other words, a fixed amount) to be paid for drawing a four of a kind can be adopted as the initial amount. Alternatively, the initial amount may be varied for each dividend amount associated with a rank constituting a hand of a four of a kind.

While a mode in which the server computer 250 updates a progressive accumulated amount in accordance with an amount having been bet at each station apparatus 300 will be described in the present embodiment, this configuration is not restrictive. For example, a configuration may be adopted in which respective master apparatuses (not shown) of game halls at a plurality of locations are connected to each other through a network. In this configuration, an original master apparatus (not shown) which further manages the respective master apparatuses may be provided and the original master apparatus may manage progressive accumulated amounts. Alternatively, a mode in which a plurality of station apparatuses 300 are intensively installed such as a game hall may not be adopted. For example, a program which causes the station apparatus 300 described in the present embodiment to function as a game apparatus of poker may be installed in a personal computer (not shown) used by an individual. In addition, a configuration may be adopted in which the server computer 250 manages respective personal computers (not shown) through the Internet.

In addition, in the present embodiment, a mode in which data of a bet amount is transmitted from each station apparatus 300 to the server computer 250 will be described as an example. In the mode of the described example, a part of the transmitted amount is distributed by the server computer 250 and added to each dividend amount. In other words, a mode in which a bet amount itself is transmitted from each station apparatus 300 to the server computer 250 and the server computer 250 uses an amount corresponding to a part of the received bet amount as a distribution object will be described as an example. However, a mode may be adopted in which an amount to be a distribution object itself is transmitted from each station apparatus to the server computer 250. In any mode, an amount corresponding to a part of a bet amount may be distributed and respectively added to a dividend amount of each newly created hand.

### Station Apparatus

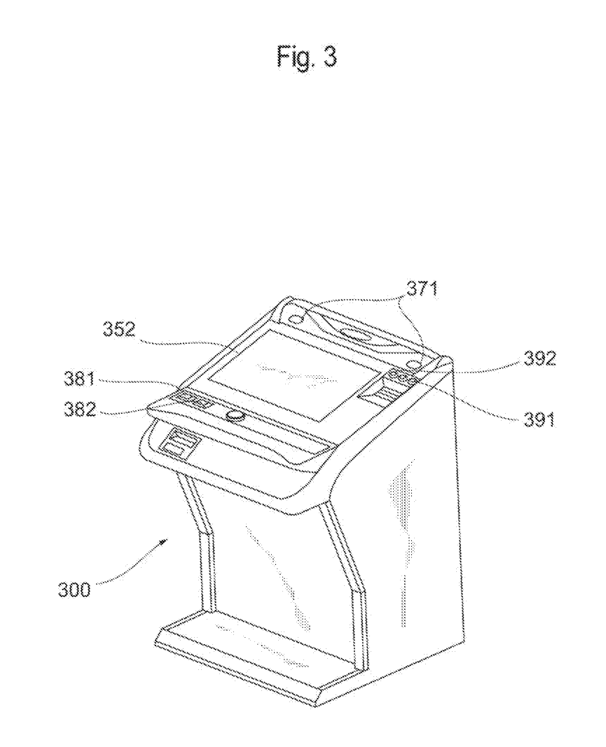

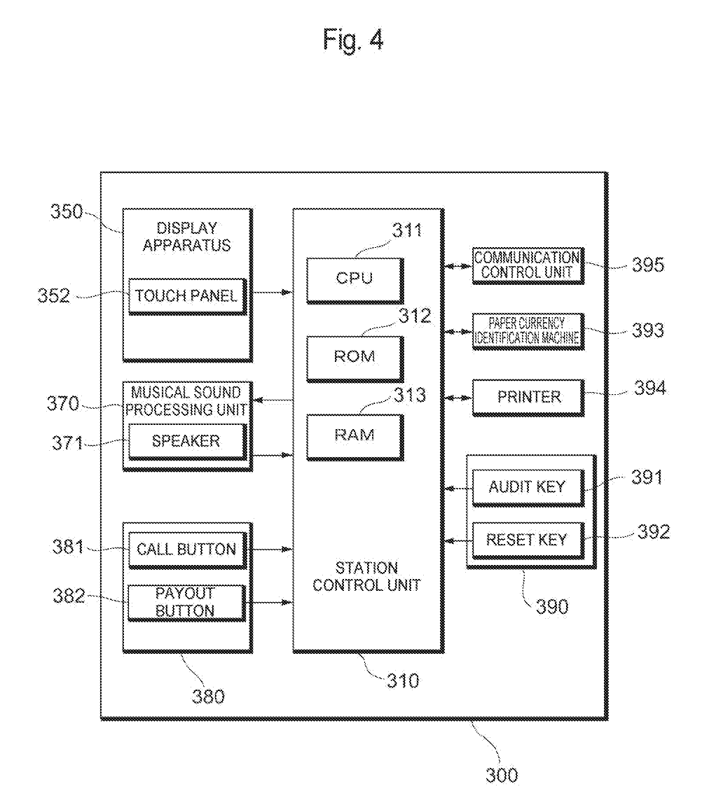

FIG. 3 is an external view of the station apparatus 300. A touch panel 352 for displaying a game screen and accepting operations from a user is provided on an upper surface portion of the station apparatus 300. In addition, in the station apparatus 300, speakers 371 which output sound effects of various presentations, musical compositions, and the like are installed so as to sandwich the touch panel 352 from left and right thereof. An operation input unit comprising a call button 381, a payout button 382, an audit key 391, and a reset key 392 is also installed in the station apparatus 300. Descriptions of these components will be given with reference to a block diagram shown in FIG. 4.

FIG. 4 is a block diagram of the station apparatus 300.

As shown in FIG. 4, a station control unit 310 is provided with a CPU 311, a ROM 312, a RAM 313, and the like. The CPU 311 centrally controls the respective units of the station apparatus 300 using various control programs and various pieces of control data stored in the ROM 312 or the RAM 313. The ROM 312 stores a program for performing a game of poker. The RAM 313 is used to temporarily store data of a game of poker in progress. The RAM 313 also stores data indicating a progressive accumulated amount transmitted from a master apparatus. In addition, the ROM 312 and the RAM 313 store algorithms, data, and the like necessary for calculating a dividend at each station apparatus 300.

A display apparatus 350 is a display unit which displays various screens comprising a main screen under the control of the station control unit 310. In addition, the touch panel 352 is provided on a front surface of the display apparatus 350. The touch panel 352 functions as an input unit used to perform various operations (a hold operation of dealt cards, a bet operation of chips, and the like) related to a card game.

A musical sound processing unit 370 generates sound effects when performing various presentations, musical compositions, and the like by reading and reproducing musical sound data and the like stored in various memories or recording media. The generated musical sounds such as sound effects are output to the outside via the speakers 371.

An operating button group 380 is provided with the call button 381 for calling a clerk when a malfunction or the like occurs, the payout button 382 for requesting a payout of a ticket corresponding to a credit, and the like. All of these operating buttons are configured to be operable by a user.

A setting key group 390 is provided with the audit key 391 for performing a trial operation of the station apparatus 300, the reset key 392 operated when a clerk pays out a ticket or the like, and the like which can be configured and operated by an operator or the like of a card game.

A paper currency identification machine 393 is an apparatus for identifying a type, a denomination, and the like of paper currency (for example, a Hong Kong dollar bill) which is fed to a cash feeding port by a user when participating in a card game or the like. A printer 394 is an apparatus for printing a ticket to be paid out after the end of a game and the like.

The communication control unit 395 controls communication with the server computer 250.

### Block Diagram of Management Apparatus and Game Apparatus

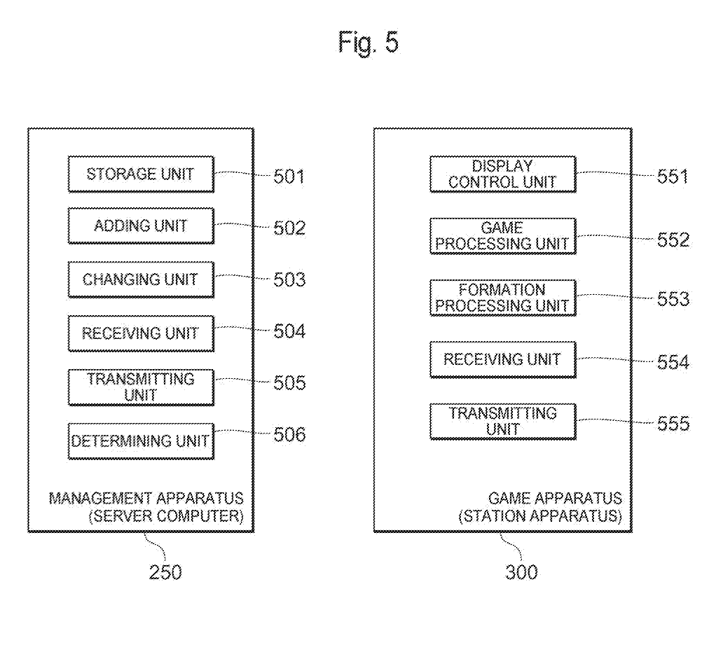

FIG. 5 is a block diagram showing functional configurations of the server computer 250 which functions as a management apparatus and the station apparatus 300 which functions as a game apparatus.

The server computer 250 is provided with a storage unit 501, an adding unit 502, a changing unit 503, a receiving unit 504, a transmitting unit 505, and a determining unit 506. The respective units of the server computer 250 shown in FIG. 5 may be caused by the CPU 251a to function as respective units of the server computer 250 when a program stored in the ROM 251b shown in FIG. 2 is temporarily read out to the RAM 251c and the CPU 251a executes the program read out to the RAM 251c.

The storage unit 501 is provided in the RAM 251c and stores various types of data. For example, the storage unit 501 stores, in the RAM 313, a dividend amount (a progressive accumulated amount) associated with each rank of cards constituting a hand of a four of a kind in poker. In other words, the storage unit 501 stores dividend amounts of four Xs in the RAM 313. In addition, the storage unit 501 stores, in the RAM 313, a dividend amount (a progressive accumulated amount) of a hand which is drawn when a four of a kind is formed and when a card satisfying a specific condition but not constituting the hand is a specific card. In other words, the storage unit 501 stores a dividend amount of a four grand in the RAM 313.

The adding unit 502 distributes at least a part of an amount having been bet at each station apparatus 300 and adds the distributed part to each dividend amount stored in the storage unit 501. The adding unit 502 is capable of varying a percentage to be distributed in accordance with each dividend amount (each progressive accumulated amount) of a four Xs. Details will be presented later.

When a hand of a four of a kind is formed at any of the station apparatuses 300, the changing unit 503 transmits, through the transmitting unit 505, an instruction to pay out the dividend amount (the progressive accumulated amount) associated with the rank of the cards constituting the hand of a four of a kind to the station apparatus 300 at which the hand has been formed. In addition, the changing unit 503 changes the dividend amount associated with the rank of the cards constituting the hand of a four of a kind transmitted from the station apparatus 300 at which the hand has been formed to an initial amount. The initial amount can be arbitrarily set.

The receiving unit 504 receives data transmitted from each station apparatus 300. For example, the receiving unit 504 receives data related to a bet amount transmitted from each station apparatus 300. In addition, the receiving unit 504 receives data of card information (suits and ranks of five cards) used in the formed hand from the station apparatus 300 at which the hand of a four of a kind has been formed.

The transmitting unit 505 successively transmits data of a dividend amount to which an addition has been made by the adding unit 502 or data of a dividend amount changed by the changing unit 503 to each station apparatus 300 every time an addition or a change is performed. Accordingly, a user can confirm a current dividend amount in real-time.

The determining unit 506 performs various determination processes. In addition, when a hand of a four of a kind is formed at a station apparatus 300, the determining unit 506 determines whether or not a hand of a four grand is formed. Details of processes by the determining unit 506 will be described later.

The station apparatus 300 is provided with a display control unit 551, a game processing unit 552, a formation processing unit 553, a receiving unit 554, and a transmitting unit 555. The respective units of the station apparatus 300 shown in FIG. 5 may be caused by the CPU 311 to function as respective units of the station apparatus 300 shown in FIG. 5 when a program stored in the ROM 312 shown in FIG. 3 is temporarily read out to the RAM 313 and the CPU 311 executes the program read out to the RAM 313.

The display control unit 551 causes each dividend amount transmitted from the server computer 250 to be displayed on the display apparatus 350.

The game processing unit 552 executes various processes related to a game of poker. For example, the game processing unit 552 activates a poker game based on a program stored in the ROM 312. In addition, the game processing unit 552 outputs an instruction to the display control unit 551 and causes a game screen of the poker game to be displayed on the display apparatus 350. Details of the game screen will be described later.

When a hand of a four of a kind is formed as a result of the game processing unit 552 executing a game, the formation processing unit 553 performs a process of paying a user a dividend amount (a progressive amount) associated with a rank of the cards constituting the hand. Specifically, when a hand of a four of a kind is formed, the formation processing unit 553 causes data of card information (suits and ranks of five cards) used in the formed hand to be transmitted to the server computer 250 using the transmitting unit 555. A dividend in accordance with the card information and a payment instruction thereof are transmitted from the server computer 250. When the receiving unit 554 receives the payment instruction, the formation processing unit 553 updates a credit amount of a user stored in the RAM 313 by adding the dividend amount transmitted from the server computer 250 to the credit amount.

The receiving unit 554 receives data of each dividend amount from the server computer 250 as needed. In addition, when a hand of a four of a kind is formed, the receiving unit 554 receives a dividend in accordance with card information and a payment instruction thereof.

When a hand of a four of a kind is formed, the transmitting unit 555 transmits information on the cards used in the formed hand to the server computer 250. In addition, the transmitting unit 555 transmits data of an amount having been bet to the server computer 250.

### Game Screen

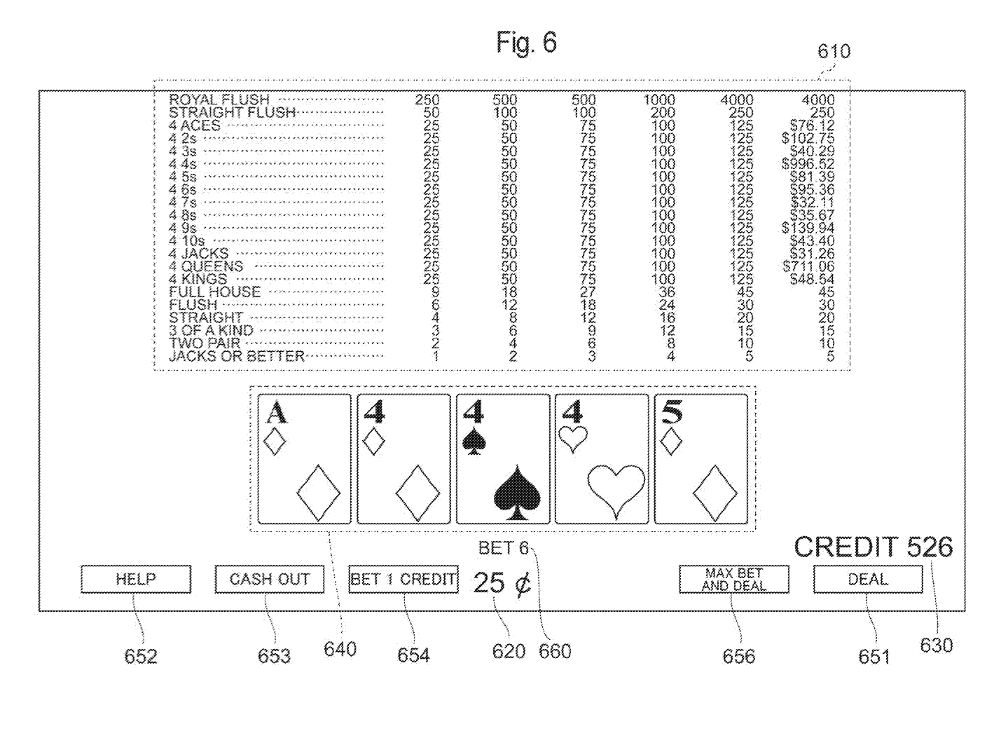

FIG. 6 is a diagram showing an example of a game screen 600 of poker which is displayed on the display apparatus 350 of the station apparatus 300 according to the present embodiment. FIG. 6 represents an example of the game screen 600 in a state where a user has placed a bet and cards have been dealt.

The game screen 600 comprises a dividend display area 610 which indicates a dividend amount and a card display area 640 which displays cards dealt to a user. In addition, the game screen 600 comprises an expression 620 indicating a money amount corresponding to one bet and an expression 630 indicating a credit owned by the user. Furthermore, the game screen 600 comprises buttons 651, 652, 653, 654, and 655 for accepting operations by the user. Hereinafter, details will be presented.

The dividend display area 610 displays each hand and a dividend amount thereof. Names of the respective hands are displayed in a column at a left end of the dividend display area 610. Dividend amounts corresponding to numbers of bet credits are respectively displayed in each of the rows of the names of the hands. In the example shown in FIG. 6, six dividend amounts are displayed for one hand. The six dividend amounts represent dividend amounts corresponding to the numbers of bet credits. Specifically, a dividend amount at a left end in the dividend display area 610 represents a dividend amount when “1 credit” is bet, and dividend amounts when bets of “2 credits”, “3 credits”, “4 credits”, and “5 credits” are made are respectively displayed in sequence from left to right. A dividend amount at a right end represents a dividend amount when “6 credits” are bet. In a poker game according to the present embodiment, a maximum amount that can be bet in one game is assumed to be “6 credits”. In the present embodiment, payment of a progressive accumulated amount is enabled when a maximum amount is bet. Among the dividend amounts displayed in the dividend display area 610, the progressive accumulated amounts at the right end are displayed in money amounts while other dividend amounts are expressed in the number of credits. In the example shown in FIG. 6, the expression 620 indicates that “1 credit” equals “25 ¢”.

For example, it is displayed that, when a hand of a “STRAIGHT” is formed, a dividend amount awarded to a user having bet “1 credit” is “4 credits”. It is also displayed that, when a hand of a “STRAIGHT” is formed, a dividend amount awarded to a user having bet “5 credits” is “20 credits”.

For example, when “1 credit” (=25 ¢) is bet, the “part of an amount having been bet” described earlier can be set to “0.25 ¢”. While this example represents an example where an amount corresponding to 1 percent of an amount having been bet is the “part of an amount having been bet”, an arbitrary percentage may be used instead. In addition, the percentage may be changed in accordance with a bet amount. For example, when “5 credits” (=125 ¢) are bet, “2.5 ¢” representing 2 percent thereof may be used as the “part of an amount having been bet”.

Five dealt cards are displayed in the card display area 640. When the user touches a card which the user does not wish to be replaced, the card enters a “HELD” state (a hold state). When the user touches a DEAL button 651, the game processing unit 552 collects cards not in the “HELD” state and redeals as many cards as those collected. When the user does not wish to replace any of the cards, the user need only touch all five cards to place the all five cards in the “HELD” state and touch the DEAL button 651. In this manner, a final combination of cards is determined. When a hand of a four of a kind is formed in the determined combination, the formation processing unit 553 transmits card information to the server computer 250 in order to pay a dividend amount corresponding to the hand.

The button 652 is a button for accepting an instruction to display rules of a game and how to play the game.

The button 653 is a button for accepting an instruction for a payout.

The button 654 is a button for accepting an instruction to bet “1 credit”. When the button 654 is touched a plurality of times, a bet of credits corresponding to the number of touches is accepted.

The button 656 is a button for accepting an instruction to bet a maximum amount that can be bet and, at the same time, to deal cards.

Let us now return to the description of the dividend display area 610. In addition to regular hands such as a “ROYAL FLUSH”, the dividend display area 610 displays the newly created 13 hands of a four of a kind (four Xs). In other words, although only one hand of a four of a kind is displayed in a regular poker game, in the present embodiment, 13 hands (four Xs) are displayed regarding a four of a kind. In this case, “4 ACES” means that the rank of the four cards constituting the hand of a four of a kind is “A”. “4 2s” means that the rank of the four cards constituting the hand of a four of a kind is “2”. “4 KINGS” means that the rank of the four cards constituting the hand of a four of a kind is “K”. The same applies to other hands.

The dividend display area 610 displays each dividend amount (progressive accumulated amount) of a hand of a four Xs which becomes a payment object when a maximum amount (in this example, “6 credits”) is bet. For example, it is displayed that, when a hand of “4 4s” is formed, a dividend amount of “996.52 $” is to be paid. Each dividend amount of the hands of a four Xs is transmitted from the server computer 250 to the station apparatus 300 as needed to be updated and displayed as needed.

Moreover, although not shown in the example in FIG. 6, a dividend amount of a four grand may be displayed in the dividend display area 610.

### Progressive Accumulated Amount

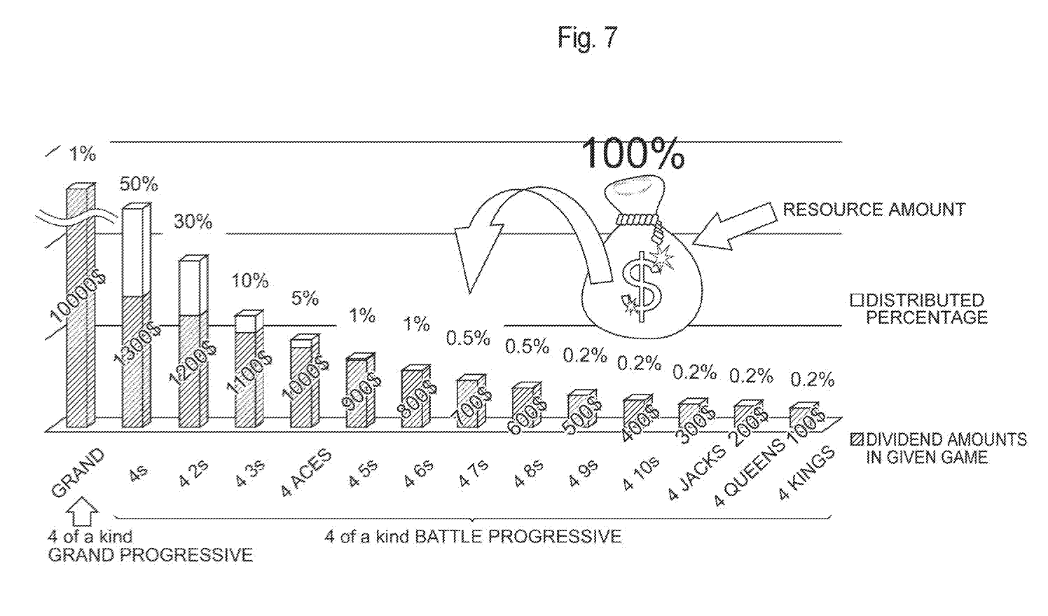

FIG. 7 is a diagram for explaining a progressive accumulated amount (a dividend amount). It should be noted that money amounts of the dividend amounts shown in FIG. 7 have been changed from the dividend amounts shown in FIG. 6 for the sake of brevity.

FIG. 7 shows progressive accumulated amounts (dividend amounts) corresponding to the 13 hands (four Xs) which corresponds to ranks constituting a hand of a four of a kind. As described earlier, these progressive accumulated amounts will be collectively referred to as a “battle progressive”.

FIG. 7 also shows a progressive accumulated amount (a dividend amount) of a hand (a four grand) which is drawn when a hand of a four of a kind is formed and when a card satisfying a specific condition but not constituting the hand is a specific card. As described earlier, this progressive accumulated amount will be referred to as a “grand progressive”.

Conditions under which a four grand is formed will be described. In the present embodiment, a four grand is a hand having, as a first condition, a formation of a hand of a four Xs with a largest progressive accumulated amount at a time point of a formation of a four of a kind. In addition, when the first condition is satisfied, a four grand is a hand which is only formed when a single remaining card not involved in the formation of the hand of a four Xs (hereinafter, referred to as a “grand card”) matches a specific card. In the present embodiment, it is assumed that the specific card is a card describing a rank of “A”. This card may be of any suit. When the rank of the four cards constituting a formed hand of a four of a kind is “A” (in other words, when a hand of four As is formed), the specific card becomes a card of another rank. For example, the rank of the specific card can be “2”. The rank of the specific card can be appropriately designated and set to an arbitrary rank by an operator side.

A specific example will now be described. In the example shown in FIG. 7, the four Xs which forms a battle progressive with a largest amount is “4 4s (four 4s)”. Therefore, the formation of a hand of a four of a kind by four “4” cards constitutes the first condition. In addition, a four grand is formed when the single remaining grand card is “A”. The formation of a four grand means that, naturally, the hand of a four Xs with a largest progressive accumulated amount at that time point has also been formed. Therefore, in the example shown in FIG. 7, the user can win a sum of both the progressive accumulated amount associated with four 4s and the grand progressive. Once a four grand is formed, conditions under which a four grand is next formed are to be changed. In other words, once a four grand is formed, a hand of a four Xs with a largest dividend amount at that time point is also formed. The dividend amount of the four Xs is changed to an initial amount after payment is completed. Therefore, in a next game, a different four Xs has become the four Xs with a largest dividend amount. For this reason, conditions under which a four grand is formed are also dynamically changed.

As described earlier, a resource of dividend amounts of four Xs and a dividend amount of a four grand is a part of an amount bet by a user. Hereinafter, the “part of an amount bet by a user” will be referred to as a “resource amount”. For example, as described earlier, when “1 credit” is bet, the resource amount can be set to “0.25 ¢”.

In the present embodiment, the resource amount is distributed to the dividend amounts of the respective hands of a four Xs and the dividend amount of a four grand. In the present embodiment, the resource amount is not distributed evenly but distributed at different ratios.

Specifically, a percentage at which the resource amount is to be distributed is increased for a hand of a four Xs with a large accumulated dividend amount at that time point. Conversely, a percentage at which the resource amount is to be distributed is reduced for a hand of a four Xs with a small accumulated dividend amount.

More specifically, a largest percentage at which the resource amount is to be distributed is set for a hand of a four Xs with a largest accumulated dividend amount at that time point. In the example shown in FIG. 7, the hand of a four Xs with a largest accumulated dividend amount at that time point is four 4s. Therefore, an example is shown in which an amount corresponding to 50 percent of the resource amount is distributed to the dividend amount associated with the four 4s. On the other hand, a hand of a four Xs with a smallest accumulated dividend amount is four Ks and, therefore, an example is shown in which only 0.2 percent of the resource amount is distributed to the dividend amount associated with the four Ks.

Further specifically, the distribution is performed such that a percentage distributed to up to three hands of a four Xs with the largest accumulated dividend amounts at that time point is equal to or larger than 70 percent. In the example shown in FIG. 7, the three hands of a four Xs with the largest accumulated dividend amounts are four 4s, four 2s, and four 3s. An example is shown in which 90 percent of the resource amount is distributed to these three hands.

Alternatively, a percentage of each dividend amount in a total dividend amount of four Xs accumulated at that time point may be obtained and a percentage at which the resource amount is to be distributed may be determined based on the obtained percentage. For example, a process of distributing 80 percent of the resource amount may be performed on a hand with a dividend amount that makes up 80 percent of the total dividend amount.

A matter common to the above methods is that, with respect to a hand of a four Xs which is least formed at that time point (in other words, a hand of a four Xs with a largest dividend amount), a distribution percentage is relatively increased as compared to other hands. As a result, the dividend for the hand of a four Xs which is least formed further prominently increases. Therefore, an extremely large dividend is to be set as the dividend for the hand of a four Xs which is least formed. A hand of a four Xs to which such a large dividend is set is not to be fixed. For example, while the example shown in FIG. 7 represents an example where four 4s is the least formed hand, in another example, another hand of a four Xs may be the least formed hand. As described earlier, when a four Xs is formed, the dividend amount thereof is changed to an initial amount. As a result, from the perspective of a user seeking a large dividend, a four Xs to aim for in accordance with the dividend amount also changes dynamically in real-time. Therefore, the user is prompted to select a card while sequentially checking each current progressive accumulated amount. As a result, a game apparatus for performing a poker game in which options when a user selects a card are diversified can be provided.

The example shown in FIG. 7 represents an example where a percentage distributed to a grand progressive that is a dividend amount in a case where a hand of a four grand is formed is 1 percent of the resource amount. A case where a four grand is formed has an extremely low probability since a four grand is only formed when a hand of a four Xs which has a largest progressive accumulated amount at that time point is formed and, at the same time, a grand card matches a specific card. In this manner, since the probability of forming a hand of a four grand is extremely low, a configuration is adopted in which a larger percentage of the resource amount is distributed to progressive accumulated amounts of hands of a four Xs with a higher possibility of being drawn.

Next, an example where options for card replacement of a user change due to newly creating a hand of a grand four will be described. A case in which cards of “A, 4, 4, 4, 5” have been dealt will be considered. It is assumed that, within these brackets, cards are identified as first, second, and the like in sequence from the left. In other words, a description will be given on the assumption that the first card is “A” and the fifth card is “5”. It is also assumed that, in this case, suits of the first, second, and fifth cards are a same suit.

In such a case, in a regular game of poker, one strategy that can be chosen by a user is to aim for a “ROYAL FLUSH” by holding (placing in a HELD state) the first, second, and fifth cards but replacing the third and fourth cards. Another strategy is to aim for a “FULL HOUSE” or a “4 OF A KIND” (four of a kind) by replacing the first card and/or the fifth card.

However, in the game apparatus according to the present embodiment described earlier, the assumed case is a case where a user's enthusiasm for the game becomes extremely heated. This is because the current state is one card short of forming four 4s (4 4s) which is a hand of a four Xs with a currently largest dividend amount. In addition, “A” which is the grand card for forming a hand of a four grand is already in the possession of the user. Therefore, in the event that the fifth card is replaced and a “4” card is obtained, the user can win an unimaginably large amount.

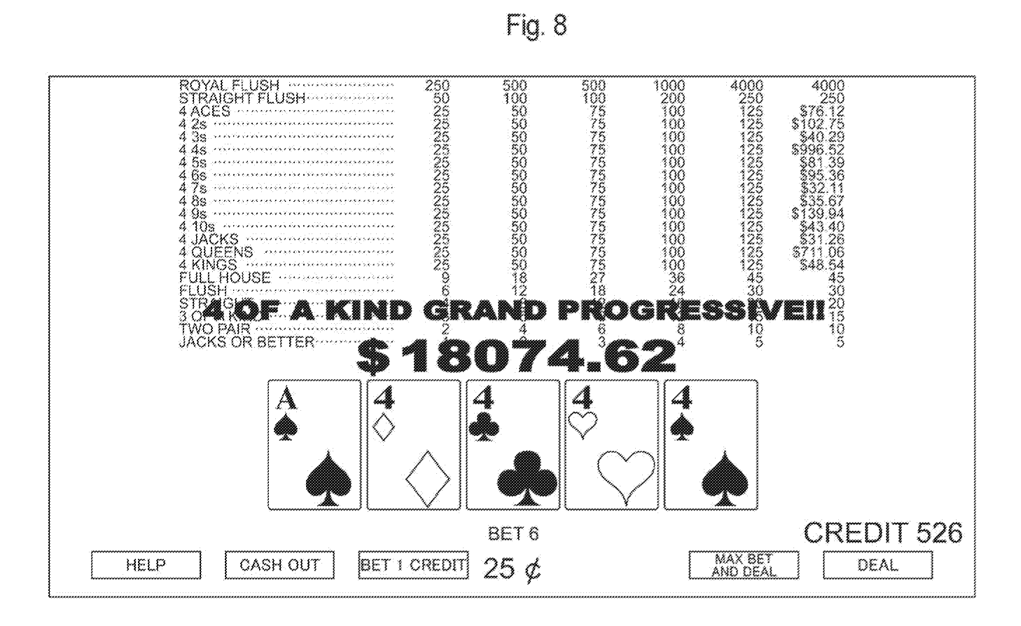

FIG. 8 is a diagram showing an example of a case where a user forms a hand of a four grand in accordance with the example described above. In this example, it is displayed that a dividend amount of “$18,074.62” is to be obtained as a grand progressive amount. Furthermore, although not illustrated, since a hand of four 4s itself is also formed, the user is to also obtain “$996.52” which is the largest progressive accumulated amount as a dividend amount.

In this manner, according to the game system of poker in the present embodiment, options of a user for card replacement diversify. In addition, since a dividend amount of a hand of a four Xs changes in accordance with a progress status of a game, the options of the user also dynamically change in accordance with the progress status of the game. For this reason, since options which may be taken by the user when selecting a card also dynamically change, the user is forced to vary strategies of card replacement every time the user plays a game. Therefore, a game system can be provided which diversifies options of a user when selecting a card as compared to conventional game systems of poker in which only a fixed dividend can be won. In addition, in the game system according to the present embodiment, a large dividend can be expected. Therefore, the number of users participating in games increases. When the number of users participating in games increases, since the number of times hands of a four Xs are formed increases while bet amounts also increase, dividends are further diversified. Since such a cycle is created, it is expected that a pace of change in options which may be taken by the user will also increase. Therefore, a game system of poker which is less likely to bore a user can be provided.

### Flow Chart

### Control Method of Station Apparatus

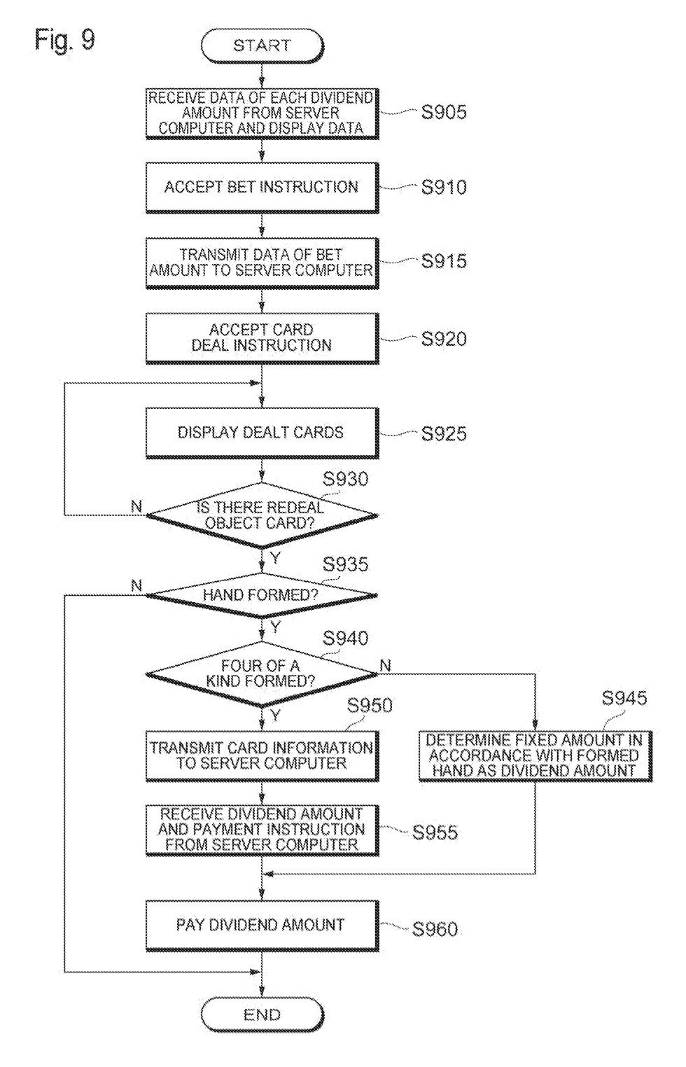

FIG. 9 is a flow chart showing an example of a control method of the station apparatus 300 according to the present embodiment. FIG. 9 represents a process in a state where a program of a poker game is being executed by the game processing unit 552.

In step S905, the receiving unit 554 receives data of each dividend amount of a four Xs and data of a dividend amount of a four grand from the server computer 250. The display control unit 551 causes each dividend amount to be displayed on the display apparatus 350. Since data of each dividend amount is transmitted as needed from the server computer 250, the display control unit 551 causes each dividend amount to be displayed on the display apparatus 350 as needed.

In step S910, the game processing unit 552 accepts a bet instruction through the touch panel 352.

In step S915, the transmitting unit 555 transmits data of a bet amount to the server computer 250.

In step S920, the game processing unit 552 accepts an instruction to deal cards (a deal instruction) through the touch panel 352.

In step S925, the game processing unit 552 determines cards to be dealt in accordance with a program of a poker game. The game processing unit 552 causes cards dealt to the user to be displayed on a game screen on the display apparatus 350 through the display control unit 551.

In step S930, the game processing unit 552 once again accepts a deal instruction from the user. At this point, a determination of whether or not there is a redeal object card is made. A redeal object card refers to a card not in a held state among the five cards displayed on the screen in step S925. When there is a redeal object card, a return is made to step S925, the game processing unit 552 determines a card to be redealt based on the program of a poker game, and causes cards dealt to the user to be once again displayed on the game screen on the display apparatus 350 through the display control unit 551. When there is no redeal object card and when redealt cards are displayed, the process advances to step S935.

In step S935, the game processing unit 552 determines whether or not a hand is formed. As a result of the process of step S930, the five cards held by the user are finalized. The determination of whether or not a hand is formed is made based on the five finalized cards. When a hand is not formed, the process is ended. When a hand is formed, the process advances to step S940.

In step S940, the game processing unit 552 determines whether or not the formed hand is a four of a kind. When a four of a kind is not formed, the process advances to step S945. When a four of a kind is formed, the process advances to step S950.

In step S945, the formation processing unit 553 determines a fixed amount in accordance with the formed hand as a dividend amount. Subsequently, the formation processing unit 553 advances to step S960.

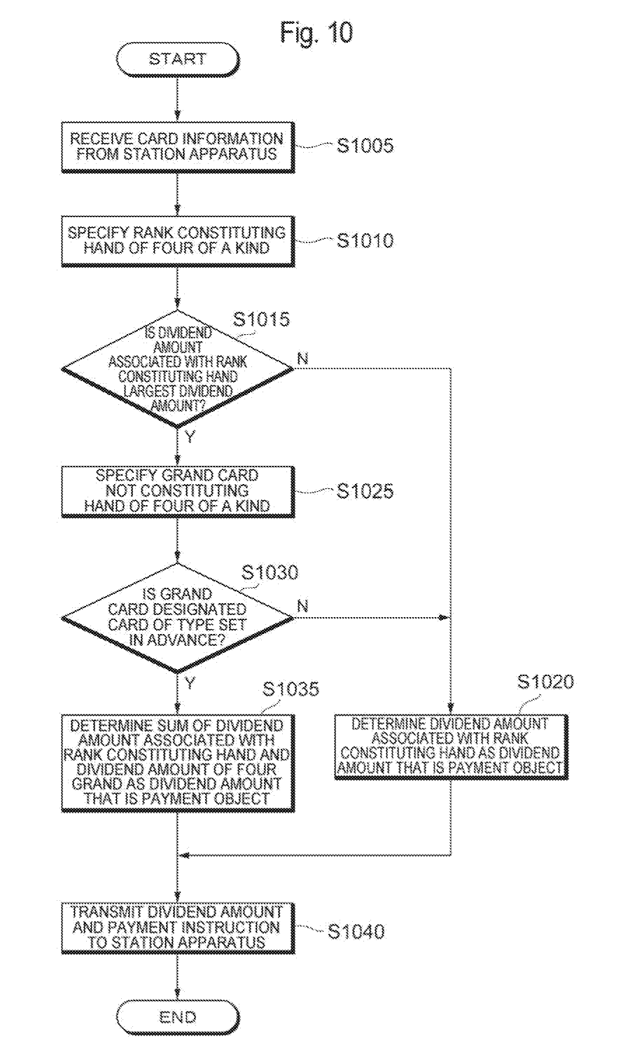

In step S950, the formation processing unit 553 transmits card information (suits and ranks) of the five cards comprising a card used in the formed hand to the server computer 250. Subsequently, a process is performed by the server computer 250. The process performed by the server computer 250 will be described later using FIG. 10.

Subsequently, in step S955, the receiving unit 554 receives a dividend amount and a payment instruction from the server computer 250.

In step S960, the formation processing unit 553 pays the dividend amount. In other words, a process of adding the dividend amount to a credit amount of the user is performed.

### Server Computer Control Method 1

FIG. 10 is a flow chart showing an example of a control method of the server computer 250. In particular, FIG. 10 is a diagram showing an example of a process of the server computer 250 when card information is transmitted in step S950 from the station apparatus 300 at which a hand of a four of a kind has been formed.

In step S1005, the receiving unit 504 receives card information from the station apparatus 300.

In step S1010, the determining unit 506 specifies a rank constituting the hand of a four of a kind based on the card information.

In step S1015, the determining unit 506 determines whether or not the dividend amount associated with the rank constituting the hand of a four of a kind is a largest dividend amount. In other words, the storage unit 501 stores 13 dividend amounts respectively associated with ranks constituting a hand of a four of a kind. The determining unit 506 determines whether or not the dividend amount associated with the rank specified in step S1010 is the largest dividend amount among the 13 dividend amounts. When the dividend amount is not the largest dividend amount, the process advances to step S1020. When the dividend amount is the largest dividend amount, the process advances to step S1025.

In step S1020, the determining unit 506 determines the dividend amount associated with the rank constituting the hand specified in step S1010 as a dividend amount that is a payment object. Subsequently, the process advances to step S1040.

In step S1025, the determining unit 506 specifies a card (a grand card) not constituting the hand of a four of a kind.

In step S1030, the determining unit 506 determines whether or not the grand card specified in step S1025 is a designated card of a type set in advance. As described earlier, in the present embodiment, the designated card is a card with a rank of “A”. In an exceptional case, when the card constituting a hand of a four of a kind is a card with a rank of “A”, the designated card is a card with a rank of “2”. Obviously, the designated card is not limited thereto and an arbitrary card may be set as the designated card. For example, the operator side may set and fix the designated card in advance or the designated card may be changed on a regular basis using roulette, a slot machine, or the like. When the grand card is the designated card, the process advances to step S1035. When the grand card is not the designated card, the process advances to step S1020.

In step S1035, the determining unit 506 determines an amount obtained by adding up the dividend amount associated with the rank constituting the hand of a four of a kind and a dividend amount of a four grand as a dividend amount that is a payment object.

In step S1040, the transmitting unit 505 transmits the dividend amount that is a payment object and a payment instruction to the transmission source station apparatus 300 which had transmitted the card information in step S1005.

### Server Computer Control Method 2

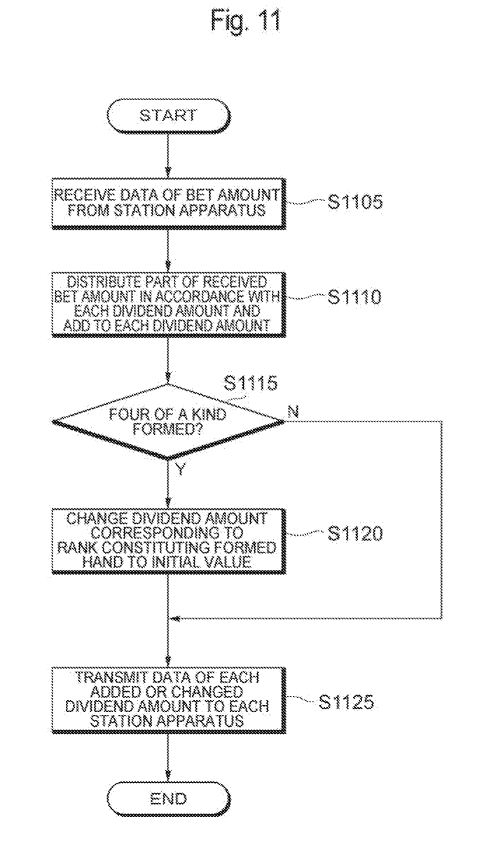

FIG. 11 is a diagram showing an example of another control method of the server computer 250. FIG. 11 represents an example of a process in a case where data of a bet amount is transmitted from a station apparatus in step S915 shown in FIG. 9.

In step S1105, the receiving unit 504 receives data of a bet amount from each station apparatus 300.

In step S1110, the adding unit 502 distributes at least a part of the bet amount received in step S1105 (for example, an amount corresponding to 1 percent of the bet amount) in accordance with each dividend amount stored in the storage unit 501 and adds the distributed part to each dividend amount. As described earlier, when distributing and adding the bet amount that is an addition object to each dividend amount, the adding unit 502 performs a process of varying the percentage at which the bet amount is to be distributed. Moreover, each dividend amount stored in the storage unit 501 is sequentially updated. Therefore, when focusing on a particular game G1 performed on a particular station apparatus 300-1, the particular game G1 is played and a dividend amount is determined. A bet amount that is bet in a next game G2 is to be distributed based on the determined dividend amount. For example, assuming that a hand of four 5s has been formed in the particular game Gl, the dividend amount of the four 5s is changed to an initial value. An amount that is bet in the game G2 following the particular game G1 is to be distributed based on the dividend amount after the change.

In step S1115, the determining unit 506 determines whether or not a four of a kind is formed. The determination can be made in accordance with a presence or an absence of card information transmitted from the station apparatus 300 in step S950 shown in FIG. 9. When a four of a kind is not formed, the process advances to step S1125. When a four of a kind is formed, the process advances to step S1120.

In step S1120, the changing unit 503 changes a dividend amount corresponding to the formed hand to an initial amount. In other words, a rank constituting the formed hand of a four of a kind is specified based on the card information transmitted from the station apparatus 300 in step S950. The changing unit 503 changes a dividend amount associated with the rank to an initial amount.

In S1125, the transmitting unit 505 transmits data of each dividend amount to which an addition has been made in step S1110 or data of a dividend amount changed in step S1120 to each station apparatus 300.

### Modification 1

In the examples described above, a mode in which the adding unit 502 varies a percentage at which a bet amount that is an addition object is to be distributed has been described as an example. A purpose of creating a variation in dividend amounts of four Xs is to diversify options when a user selects cards or to motivate a user to form a hand of a four Xs with a largest dividend amount which is a requirement for the formation of a hand of a four grand. However, the adding unit 502 need not vary a percentage at which a bet amount that is an addition object is to be distributed. The adding unit 502 according to modification 1 may uniformly distribute and add a bet amount that is an addition object to each dividend amount. As described earlier, even in a case of uniform distribution, when a hand is formed, a dividend amount associated with a rank of the formed hand is to be changed to an initial amount. As the game progresses, due to hands of a four of a kind being formed from time to time, a variation in the respective dividend amounts is to be created as a consequence. Therefore, a game system of poker can be provided in which options when a user selects cards are diversified even in a case where a bet amount is to be uniformly distributed. In addition, even in the conditions of forming a hand of a four grand, since the fact that a least formed four Xs (a four Xs with a largest dividend amount) exists remains the same, the hand of a four grand can be maintained in a similar manner.

### Supplement 1

The description thus far is premised on an example where a joker is not included. A joker is a wild card and can be used to substitute for any card. The processes of the embodiment described above can also be applied to a mode which uses a joker. When using a joker, a five of a kind may be formed as a hand. Whether to enable a five of a kind to be formed or to enable a four Xs (and a grand four) to be formed may be determined by the server computer 250 in accordance with dividend amounts.

### Supplement 2

As described earlier, in the present embodiment, data of a dividend amount of a four Xs is configured as state data to which an addition can be made but of which a payment is prohibited until a hand of the four Xs is formed. In other words, the data is in a state where an addition can be made thereto but a payment thereof is not performed. A conversion key for converting the state data to which an addition can be made but of which a payment is prohibited into state data to which an addition cannot be made but of which a payment can be performed is data indicating that a hand of a four Xs has been formed. In addition, when a hand of a four Xs is formed, only a dividend amount associated with a rank of cards constituting a hand of a four of a kind is converted from state data to which an addition can be made but of which a payment is prohibited into state data to which an addition cannot be made but of which a payment can be performed. Accordingly, the dividend amount is determined. The determined dividend amount is transmitted to the station apparatus 300 at which the hand of a four of a kind has been formed. After the dividend amount is determined, the data of the dividend amount is converted from state data to which an addition cannot be made but of which a payment can be performed into state data to which an addition can be made but of which a payment is prohibited. The contents described above can be organized into an alternate aspect such as that described below.

### Alternate Aspect

A game system comprising a management apparatus which manages a plurality of game apparatuses,
the management apparatus comprising:
a storage unit which stores a dividend amount associated with each rank of cards constituting a hand of a four of a kind in poker as state data to which an addition can be made but of which a payment is prohibited;
an adding unit which distributes and adds at least a part of an amount having been bet at each of the game apparatuses to each dividend amount stored in the storage unit;
a first converting unit which, when the hand of a four of a kind is formed at any of the game apparatuses, converts state data of a dividend amount associated with a rank of cards constituting the hand into state data to which an addition cannot be made but of which a payment can be performed;
a changing unit which transmits an instruction to pay the dividend amount having been converted into the state data to which an addition cannot be made but of which a payment can be performed to the game apparatus at which the hand has been formed and which changes the dividend amount that is associated with the rank of cards constituting the hand and is transmitted from the game apparatus, to an initial amount;
a second converting unit which converts state data of the dividend amount having been changed by the changing unit into state data to which an addition can be made but of which a payment is prohibited; and
a transmitting unit which transmits data of the added or changed dividend amount to each of the plurality of game apparatuses.

### Supplement 3

In addition, as described earlier, data of a dividend amount of a grand four in the present embodiment is data in a payment-prohibited state until specific conditions are satisfied. A prohibited state release key for causing a state transition from the payment-prohibited state to a payment-allowed state is data indicating that a hand of a four Xs for which a largest dividend amount is being accumulated at that time point has been formed. In the event that a grand card matches a designated card when a transition of data of a dividend amount of a grand four to a payment-allowed state is made by the prohibited state release key, the data of the dividend amount of a grand four is converted into a payment state. A payment process of the data of the dividend amount of a grand four is executed only when the data has been converted into a payment state. In the present embodiment, it can be argued that a process of dynamically varying generation conditions of the prohibited state release key is being performed in accordance with a progress of a game.

The embodiment described above is presented in order to facilitate understanding of the present disclosure and is not intended to limit the interpretation of the present disclosure. The respective elements constituting the embodiment as well as arrangements, materials, conditions, shapes, sizes, and the like of the elements are not limited to those exemplified above and can be modified as deemed appropriate. In addition, configurations respectively described in different embodiments can be partially replaced by or combined with one another.

A program for realizing the respective embodiments described above may be stored in a recording medium. The recording medium can be used to install the program described above on a computer which manages a waiting list of reservations at a facility. In this case, the recording medium storing the program described above may be a non-transitory recording medium. While the non-transitory recording medium is not particularly limited, for example, the non-transitory recording medium may be a recording medium such as a CD-ROM.

### LIST OF REFERENCE NUMERALS

100 Game system

200 Master apparatus

230 Main monitor

250 Server computer

251 Master control unit

251a CPU

251b ROM

251c RAM

252 Communication control unit

252a Communication interface

253 Monitoring display

254 Input unit

300 Station apparatus

310 Station control unit

350 Display apparatus

352 Touch panel

370 Musical sound processing unit

371 Speaker

380 Operating button group

381 Call button

382 Payout button

390 Setting key group

391 Audit key

392 Reset key

393 Paper currency identification machine

394 Printer

395 Communication control unit

501 Storage unit

502 Adding unit

503 Changing unit

504 Receiving unit

505 Transmitting unit

506 Determining unit

551 Display control unit

552 Game processing unit

553 Formation processing unit

554 Receiving unit

555 Transmitting unit

1. A game system comprising a management apparatus which manages a plurality of game apparatuses,
the management apparatus including:
a storage unit which stores a dividend amount associated with each rank of cards constituting a hand of a four of a kind in poker;
an adding unit which distributes and adds at least a part of an amount having been bet at each of the game apparatuses to each dividend amount stored in the storage unit;
a changing unit which, when the hand of a four of a kind is formed at any of the game apparatuses, transmits an instruction to pay a dividend amount associated with a rank of cards constituting the hand, to the game apparatus at which the hand has been formed, and changes the dividend amount that is associated with the rank of cards constituting the hand and is transmitted from the game apparatus, to an initial amount; and
a transmitting unit which transmits data of the added or changed dividend amount to each of the plurality of game apparatuses.

2. The game system according to claim 1, wherein
the game apparatus includes:
a display unit which displays the dividend amount;
a processing unit which, when the hand of a four of a kind is formed, transmits a rank of cards constituting the hand to the management apparatus, and pays a dividend amount associated with the rank of cards constituting the hand based on an instruction to pay the dividend amount transmitted from the management apparatus; and
a transmitting unit which transmits data of an amount having been bet to the management apparatus.

3. The game system according to claim 1, wherein the adding unit varies a percentage at which at least a part of an amount to be bet in a next game is distributed in accordance with the each dividend amount.

4. The game system according to claim 3, wherein the adding unit increases the percentage at which at least a part of the amount to be bet in the next game is distributed such that the larger the dividend amount of a hand, the larger the percentage distributed to the hand.

5. The game system according to claim 3, wherein the adding unit sets, for the largest dividend amount, a largest percentage at which the amount to be bet in the next game is distributed.

6. A control method of a management apparatus which manages a plurality of game apparatuses, the control method comprising the steps of:
distributing and adding at least a part of an amount having been bet at each of the game apparatuses to each dividend amount stored in a storage unit which stores a dividend amount associated with each rank of cards constituting a hand of a four of a kind in poker;
when the hand of a four of a kind is formed at any of the game apparatuses,
transmitting an instruction to pay a dividend amount associated with a rank of cards constituting the hand to the game apparatus at which the hand has been formed, and
changing the dividend amount that is associated with the rank of cards constituting the hand and is transmitted from the game apparatus, to an initial amount; and
transmitting data of the added or changed dividend amount to each of the plurality of game apparatuses.

7. A control method of a game apparatus which is managed by a management apparatus, the control method comprising the steps of:
transmitting data of an amount having been bet to the management apparatus;
receiving, from the management apparatus, a dividend amount associated with each rank of cards constituting a hand of a four of a kind in poker;
displaying the dividend amount on a display unit; and
when the hand of a four of a kind is formed,
transmitting a rank of cards constituting the hand to the management apparatus, and
paying a dividend amount associated with the rank of cards constituting the hand based on an instruction to pay the dividend amount transmitted from the management apparatus.
